(19) United States
(12) Patent Application Publication
(10) Pub. No.: US 2012/0092862 A1
(43) Pub. Date: Apr. 19, 2012

(54) STRUCTURE OF LIGHT-EMITTING DIODE (LED) HAVING HIGH COLOR RENDERING INDEX

(76) Inventors: SHIH-JEN CHUANG, Xindian City (TW); Han-Chi Chang, Xindian City (TW)

(21) Appl. No.: 12/903,208

(22) Filed: Oct. 13, 2010

(51) Int. Cl. F21V 9/00

(52) U.S. Cl. 362/231

(57) ABSTRACT

Disclosed is a structure of light-emitting diode (LED) having high color rendering index, including a substrate on which at least one light emission element, at least one red light emission element, and at least one green light emission element are mounted. The light emission element emits blue light that is also applied to excite a fluorescent powder coated outside the light emission element to generate white light, which when mixed with red and green lights from the red and green light emission elements, form a light source of improved color rendering property. With the addition of the red and green light emission elements, the light projecting from the LED structure provides a color performance close to the natural light, allowing for perfect reproduction of the original color of an object and thereby improving conformableness and coordination of human perception without causing any lose of color genuineness of an object.

### TECHNICAL FIELD OF THE INVENTION

The present invention generally relates to light-emitting diode (LED), and more particularly to a structure of LED that has a high color rendering index for faithfully reproducing the true color of an object, improving comfortableness and coordination of human perception, and does not cause lose of genuineness of color.

### DESCRIPTION OF THE PRIOR ART

With the progress of light-emitting diode (LED) technology, LEDs get wider and wider applications in varied fields and become one of the vital lighting devices in our lives. The current issue of energy shortage directs the developments of various lighting devices that provide improved performance in respect of reduced power consumption and saving of energy In view of this, LEDs is now attracting the public attention due to the superior advantages of power saving, high performance, high brightness, and versatility.

Various new LED based lighting devices have been recently developed and marketed, yet these LED based lighting devices are still not the main stream of current lighting devices. This is because of the following reasons. Firstly, the currently available LEDs that emit white light shows insufficient color rendering property, for the white LEDs are made by coating yellowish green fluorescent powder on a blue LED die, whereby blue light emitting from the blue die excites the yellowish green fluorescent powder to emit yellowish green light that, when mixed with the blue light, provides white light. However, since the three primaries in such a white light are not of even distribution, the color rendering property is poor, making it not possible to faithfully reproduce the true color of an object illuminated by such a white light. Secondly, the color temperature is excessively high and thus not easy to control, for the light source of the conventional white LED is a blue LED die, which makes the color temperature of the white light high, making a viewer feel more or less bluish for visual perception. These are some of the drawbacks of the conventional white LEDs.

To overcome the above mentioned drawbacks, most manufacturers use blue LED to excite green fluorescent powder and red fluorescent powder. When being excited, the two fluorescent powders emit green light and red light, which when mixed with the blue light gives off white light. In this way, the drawbacks of poor color rendering property and high color temperature can be improved. However, since the red fluorescent powder shows poor efficiency, to realize good color rendering, the percentage of red fluorescent powder used must be increased, but this eventually leads to reduction of brightness. In view of this problem, some manufacturers proposed a solution for improving color rendering by coating yellowish green fluorescent powder on a blue LED to generate white light and then adding a red LED to make overall color rendering better and also maintaining desired level of brightness. This solution works well only for white light of low color temperature.

Thus, it is desired to provide a structure of LED that overcomes the above discussed problems.

### SUMMARY OF THE INVENTION

In view of the above discussed problems, the present invention aims to provide a structure of light-emitting diode (LED) that provides excellent color rendering property so as to allow for faithful reproduction of the true color of an object, ensure comfortableness and coordination of human perception, and not cause lose of genuineness of the color of an object.

The primary objective of the present invention is to provide a light-emitting diode (LED) device of high color rendering index, which comprises a plurality of light emission elements of which a red light emission element and a green light emission element respectively generate red light having a wavelength between 595 nm and 640 nm and green light having a wavelength between 500 nm and 550 nm, which when mixed with yellowish green light having a wavelength between 545 nm and 585 nm that is generated by excitation of yellow fluorescent powder by blue light emitted from a blue light LED die and blue light from the blue LED die having a wavelength between 430 nm and 480 nm, generate white light. With the addition of two light sources, including the red light emission element and the green light emission element, the light eventually projecting from the LED structure provides a color performance that is very close to the natural light, allowing for perfect reproduction of the original color of an object and thereby improving conformableness and coordination of human perception without causing any lose of color genuineness of an object.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic structural arrangement of light emission elements according to the present invention.

FIG. 2 is a spectrum diagram of white light-emitting diode (LED) used in the present invention.

FIG. 3 is a spectrum diagram of mixed light according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

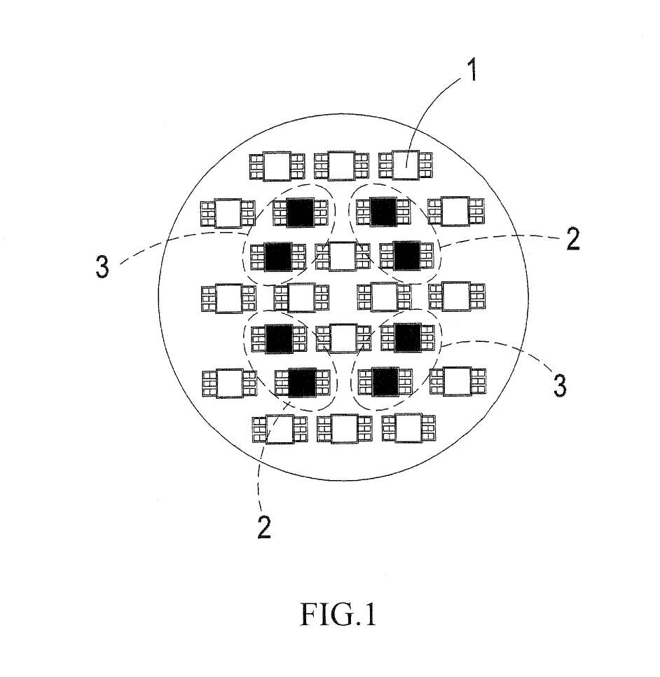

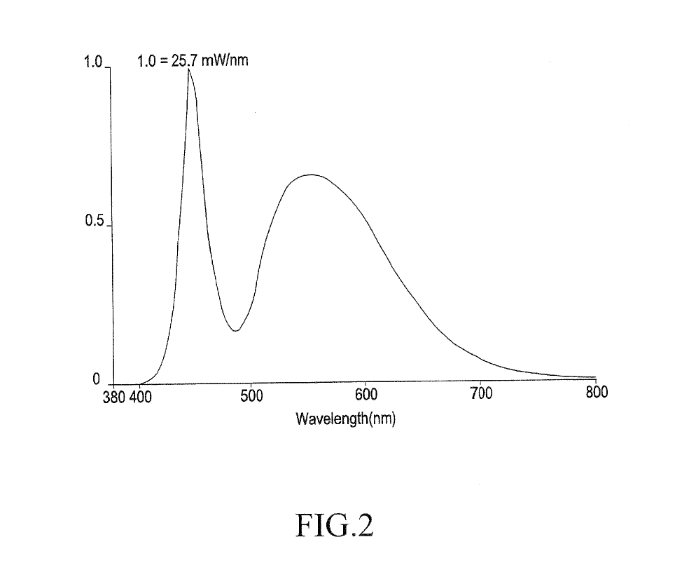

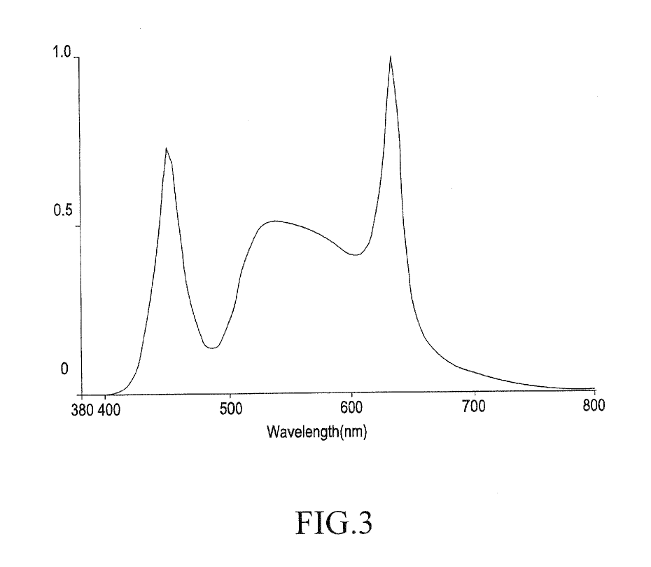

Referring to FIGS. 1-3, which respectively show a schematic structural arrangement of light emission elements according to the present invention, a spectrum diagram of white light-emitting diode (LED), and a spectrum diagram of mixed light, as shown in the drawings, the present invention provides a white light LED having high color rendering index. In the device according to the present invention, a light emission element (white light LED) is formed of a blue light source and also excitation of a fluorescent powder coated outside the light emission element to generate white light. If red light emission elements 2 and green light emission elements 3 (see FIG. 1) are not included in the device, the color rendering index is low. As shown in FIG. 2, by mixing red light (of which the wavelength is between 595 nm and 640 nm) and green light (of which the wavelength is between 500 nm and 550 nm) that are respectively emitted from the red light emission elements (such as red LEDs) and the green light emission elements (such as green LEDs) with yellowish green light that is generated by excitation of yellow fluorescent powder by the blue dies and has a wavelength between 545 nm and 585 nm) and blue light of which the wavelength is between 430 nm and 480 nm, white light is generated. With the addition of two light sources, including the red light emission elements and the green light emission elements, the light eventually projecting from the LED structure provides a color performance that is very close to the natural light, allowing for perfect reproduction of the original color of an object and thereby improving conformableness and coordination of human perception without causing any lose of color genuineness of an object.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A structure of light-emitting diode (LED) having high color rendering index, comprising:
a substrate;
at least one light emission element, which is mounted on the substrate, the light emission element being a blue light source that emits blue light that excite a fluorescent powder coated outside the light emission element to generate white light;
at least one red light emission element, which is mounted on the substrate to emit red light for mixing with the white light; and
at least one green light emission element, which is mounted on the substrate to emit green light for mixing with the white light and red light.

2. The structure of LED having high color rendering index according to claim 1, wherein the light emission element comprises a blue die that excites yellow fluorescent powder to generate yellowish green light having a wavelength between 545 nm and 585 nm for mixing with the blue light that has a wavelength between 430 nm and 480 nm.

3. The structure of LED having high color rendering index according to claim 1, wherein the red light emitted from the red light emission element has a wavelength between 595 nm and 640 nm.

4. The structure of LED having high color rendering index according to claim 1, wherein the green light emitted from the green light emission element has a wavelength between 500 nm and 550 nm.

5. The structure of LED having high color rendering index according to claim 1, wherein the fluorescent powder comprises yellowish green fluorescent powder.

6. The structure of LED having high color rendering index according to claim 1, wherein the light emission element comprises a white light LED.

7. The structure of LED having high color rendering index according to claim 1, wherein the red light emission element comprises a red light LED.

8. The structure of LED having high color rendering index according to claim 1, wherein the green light emission element comprises a green light LED.
